(19) United States
(12) Patent Application Publication
(10) Pub. No.: US 2022/0369857 A1
(43) Pub. Date: Nov. 24, 2022

(54) SYSTEM AND METHOD FOR PREPARING A MEAL

(71) Applicant: STALWART GROUP LLC, Hartland, WI (US)

(72) Inventor: Walter E. ZIMMERMAN, Hartland, WI (US)

(21) Appl. No.: 17/746,935

(22) Filed: May 17, 2022

Related U.S. Application Data
(60) Provisional application No. 63/190,231, filed on May 18, 2021.

(51) Int. Cl. A47J 36/22; A23L 5/10; A23L 35/00

(52) U.S. Cl. CPC A47J 36/22; A23L 5/10; A23L 35/00; A23V 2002/00

(57) ABSTRACT

A system and method for preparing a meal is disclosed. A meal may be prepared from foodstuffs such as ingredients of a meal kit with a cooking accessory such as a rack configured to be used with a cooking appliance for foodstuffs; the cooking accessory may comprise a support structure and at least one platform configured to support foodstuffs; the rack may be configured to at least partially fit within the cooking appliance so that foodstuffs on the at least one platform can be heated within the cooking appliance and for removal from the cooking appliance after foodstuffs have been heated. The platform may be attached to the rack or removable. The meal kit may comprise ingredients and a label configured to be detected by a mobile device to provide instructions for preparing the meal. A method of preparing the meal from the meal kit may comprise obtaining instructions.

### CROSS-REFERENCE TO RELATED APPLICATIONS

The present application claims priority to and incorporates by reference in full the following U.S. patent application: U.S. Provisional Patent Application No. 63/190,231, titled “SYSTEM AND METHOD FOR PREPARING A MEAL,” filed May 18, 2021.

### FIELD

The present invention relates to a system and method for preparing a meal.

The present invention also relates to a meal kit that can be prepared into a meal with the system and method.

### BACKGROUND

It is known to prepare a meal from a meal kit comprising a set of ingredients.

It is also known to prepare a meal in an appliance such as a pressure-time cooker such as the currently popular Instant Pot appliance that has been commercially available from Instant Brands of Kanata, Ontario, Canada.

It would be advantageous to provide an improved system and method for preparing a meal.

It would be advantageous to provide a meal kit that can be prepared into a meal with the system and method.

It would be advantageous to provide a cooking accessory such as a rack configured for use with a cooking appliance to prepare foodstuffs such as ingredients of a meal kit that into a meal.

### SUMMARY

The present invention relates to a system and method for preparing a meal.

The present invention relates to a meal kit that can be prepared into a meal with the system and method.

The present invention relates to a meal kit comprising packaged foodstuffs/ingredients that can be prepared into a meal with the system and method.

The present invention relates to a meal kit that can be prepared into a meal with the system and method.

The present invention relates to a system and method for preparing a meal in a cooking appliance with a cooking accessory.

The present invention relates to a cooking accessory for use in a cooling appliance to prepare a meal.

The present invention relates to a cooking accessory for use in a cooling appliance to prepare a meal from a meal kit.

The present invention relates to a system and method for data communications for use with a cooling appliance to prepare a meal from a meal kit.

The present invention relates to a system and method for data communications for use with a cooking accessory in a cooling appliance to prepare a meal from a meal kit.

The present invention relates to a system and method for data communications facilitated by a meal kit for use with a cooking accessory in a cooling appliance to prepare a meal from the meal kit.

The present invention relates to a system and method for data communications such as instructions, nutritional information, etc. regarding a meal facilitated by a meal kit for use with a cooking accessory in a cooling appliance to prepare the meal from the meal kit.

The present invention relates to a system and method for data communications by a vendor/supplier/reseller with customers such as instructions, nutritional information, etc. regarding a meal facilitated by a meal kit for use by the customer with a cooking accessory in a cooling appliance to prepare the meal from the meal kit

The present invention relates to a cooking accessory configured to be used with a cooking appliance for foodstuffs; the cooking accessory may comprise a support structure and at least one platform configured to be supported by the support structure; the at least one platform may be configured to support foodstuffs; the support structure and the at least one platform may be configured to fit within the cooking appliance so that foodstuffs on the at least one platform can be heated within the cooking appliance; the support structure and the at least one platform may be configured for removal from the cooking appliance after foodstuffs have been heated. The foodstuffs may comprise contents for a meal; foodstuffs may comprise a meal kit comprising a meal comprising at least one of protein and/or carbohydrate and/or vegetable matter and/or seasoning; protein may comprise meat. The meal kit may be provided in a package; the package for the meal kit comprises a label; instructions for preparing the meal for the meal kit may be provided from the label; the label may be configured to be detected by a mobile device to provide instructions. The at least one platform comprises a lower platform and an upper platform; a rack may comprise the support structure and the lower platform and the upper platform; the rack may be configured to provide a middle platform between the lower platform and the upper platform; the lower platform may be attached to the rack. At least one platform may be removable from the rack. At least one platform may comprise a set of drain holes; at least one platform may comprise a wire mesh. The rack may be configured for placement into a fluid within the cooking appliance for heating foodstuffs on at least one platform of the rack. The support structure may comprise a stand; a meal comprising foodstuffs can be heated on the stand within the cooking appliance and served from the stand.

The present invention relates to a cooking accessory such as a rack may be configured to be used with a cooking appliance for foodstuffs; the rack may comprise a support structure and at least one platform configured to be supported by the support structure; the at least one platform may be configured to support foodstuffs; the support structure and the at least one platform may be configured to fit within the cooking appliance so that foodstuffs on the at least one platform can be heated within the cooking appliance; the support structure and the at least one platform may be configured for removal from the cooking appliance after foodstuffs have been heated. The rack may comprise a handle.

The present invention relates to a method of using a cooking accessory comprising a rack configured to be used with a cooking appliance to prepare a meal comprising foodstuffs from a meal kit may comprise the steps of (a) placing the foodstuffs on at least one platform of the rack; (b) placing the rack within the cooking appliance; (c) heating the foodstuffs on the at least one platform within the cooking appliance; (d) removing the rack from the cooking appliance after foodstuffs have been heated. Foodstuffs of the meal kit may comprise ingredients such as at least one of protein and/or carbohydrate and/or vegetable matter and/or seasoning. The meal kit may be provided in a package comprising a label; the method may comprise the step of obtaining instructions for preparing the meal for the meal kit from the label. The label may be configured to be detected by a mobile device to provide instructions; wherein the label may be configured to provide a data connection to a network from the mobile device.

### FIGURES

FIG. 1 is a schematic perspective view of a cooking appliance according to an exemplary embodiment.

FIG. 2 is a schematic perspective view of a cooking accessory/tool according to an exemplary embodiment.

FIG. 3 is a schematic perspective view of a cooking accessory/tool according to an exemplary embodiment.

FIG. 4 is a schematic side elevation view of a cooking accessory/tool according to an exemplary embodiment.

FIG. 5 is a schematic side elevation view of a cooking accessory/tool according to an exemplary embodiment.

FIG. 6 is a schematic exploded perspective view of a cooking accessory/tool according to an exemplary embodiment.

FIG. 7A is a schematic perspective view of a cooking appliance with cooking accessory/tool according to an exemplary embodiment.

FIG. 7B is a schematic perspective view of a container of a cooking appliance with cooking accessory/tool according to an exemplary embodiment.

FIG. 7C is a schematic perspective view of a container of a cooking appliance with cooking accessory/tool according to an exemplary embodiment.

FIG. 8A is a schematic perspective view of a meal kit according to an exemplary embodiment.

FIG. 8B is a schematic perspective view of ingredients of a meal kit according to an exemplary embodiment.

FIG. 8C is a schematic diagram of an instruction card for preparation of a meal kit according to an exemplary embodiment.

FIG. 9 is a schematic perspective view of a meal prepared from a meal kit according to an exemplary embodiment.

FIG. 10A is a schematic side elevation view of a container of a cooking appliance with cooking accessory/tool with ingredients of a meal kit according to an exemplary embodiment.

FIG. 10B is a schematic side elevation view of a container of a cooking appliance with cooking accessory/tool with ingredients of a meal kit according to an exemplary embodiment.

FIG. 11A is a schematic side elevation view of a cooking accessory/tool with ingredients of a meal kit according to an exemplary embodiment.

FIGS. 11B and 11C are schematic side elevation views of a cooking accessory/tool with ingredients of a meal kit according to an exemplary embodiment.

FIGS. 12A and 12B are schematic perspective views of a cooking accessory/tool according to an exemplary embodiment.

FIG. 13 is a schematic side elevation view of a cooking accessory/tool according to an exemplary embodiment.

FIG. 14A is a schematic perspective view of a meal kit according to an exemplary embodiment.

FIG. 14B is a schematic perspective view of ingredients of a meal kit according to an exemplary embodiment.

FIG. 14C is a schematic diagram of a mobile device with an application providing instructions/information for preparation of a meal kit according to an exemplary embodiment.

FIG. 15 is a schematic perspective view of a meal prepared from a meal kit according to an exemplary embodiment.

FIG. 16 is a schematic perspective view of a system for preparing a meal prepared from a meal kit according to an exemplary embodiment.

### DESCRIPTION

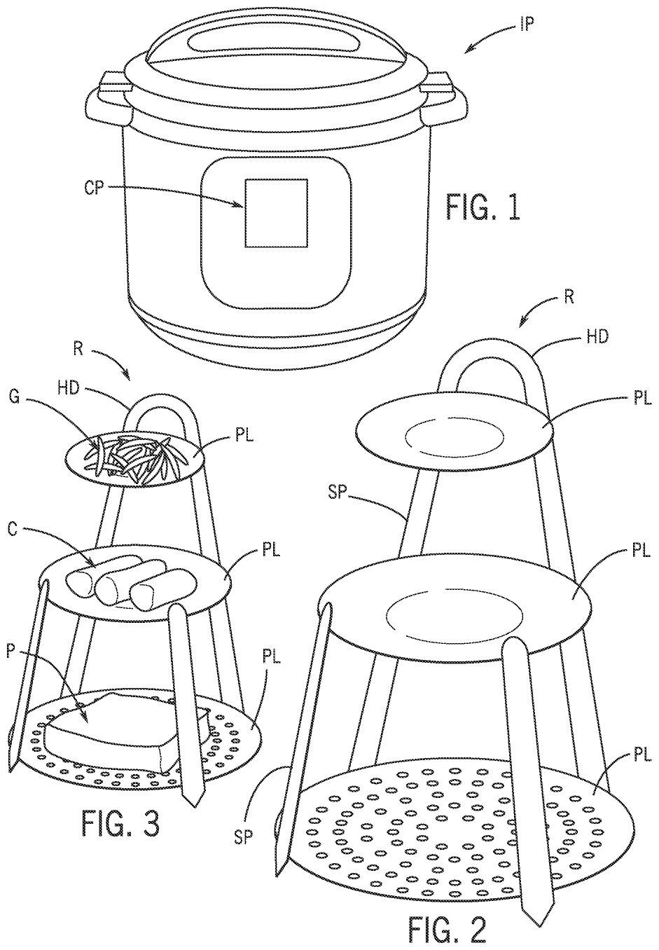

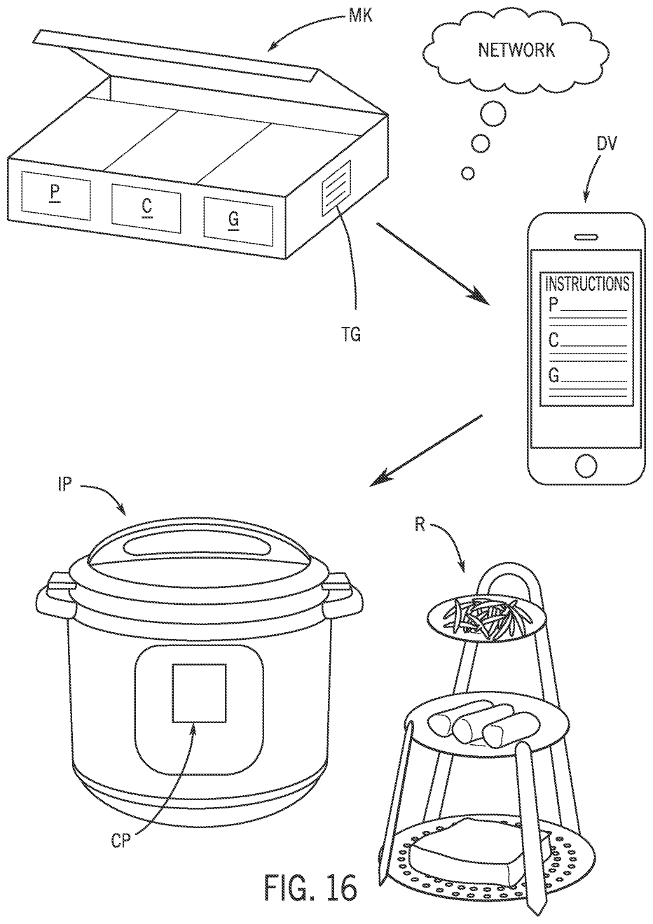

Referring to FIGS. 1, 7A-7B and 16, a cooking appliance IP is shown representationally as the commercially-available “Instant Pot” appliance configured for operation as a pressure cooker, slow cooker, etc. Cooking appliance IP comprises base BS and a cover CV along with a removable pot/liner PT (which may have a separate lid LD) to fit within the base BS. As indicated schematically in FIGS. 1 and 16, cooking appliance IP is configured to have setting and operation (e.g. time, temperature, pressure, method of operation, etc.) provided and monitored by a user at a user interface on a control panel CP and/or on a mobile device DV over a network connection as indicated schematically in FIG. 16. In common use, foodstuffs to be cooked/prepared in the cooking appliance IP are placed in the pot/liner PT in the base BS of the cooking appliance IP (e.g. on a heating element within base BS); the cover CV is closed on the base BS and settings for operation are entered at the user interface (e.g. control panel CP and/or mobile device DV). Cooking of the foodstuffs in the cooking appliance IP is initiated and monitored and completed (e.g according to a plan, recipe, instructions, personal preferences of a user/cook, etc.); after cooking is completed within the cooking appliance IP the foodstuffs within the pot/liner PT are then available to be served for a meal. See FIG. 15.

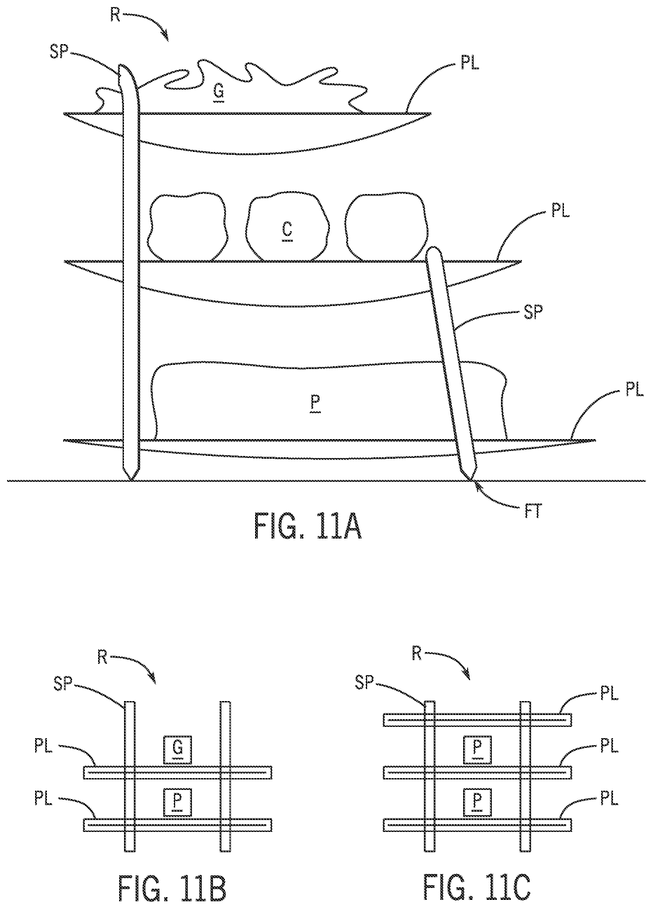

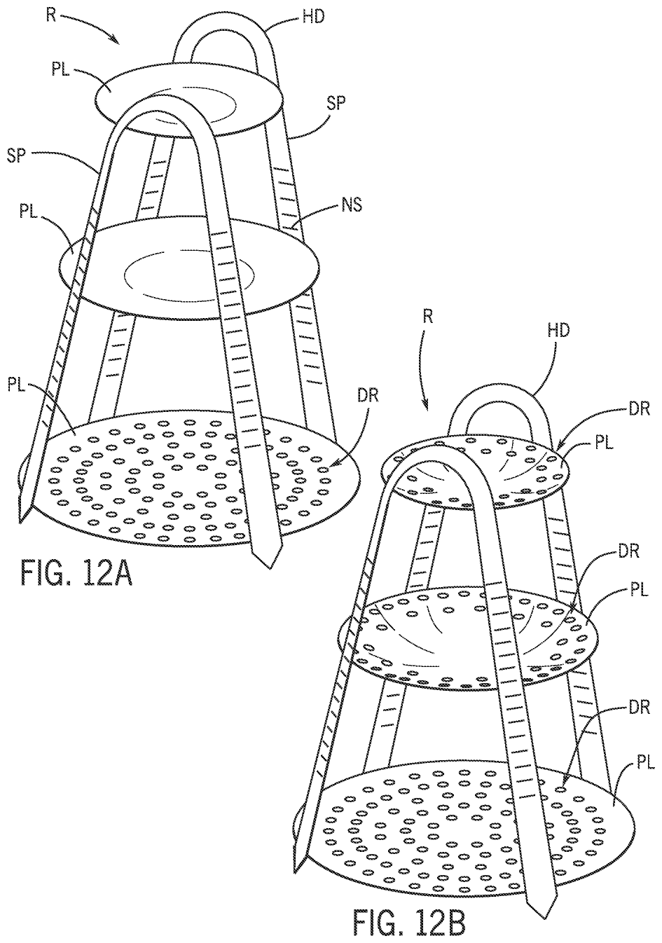

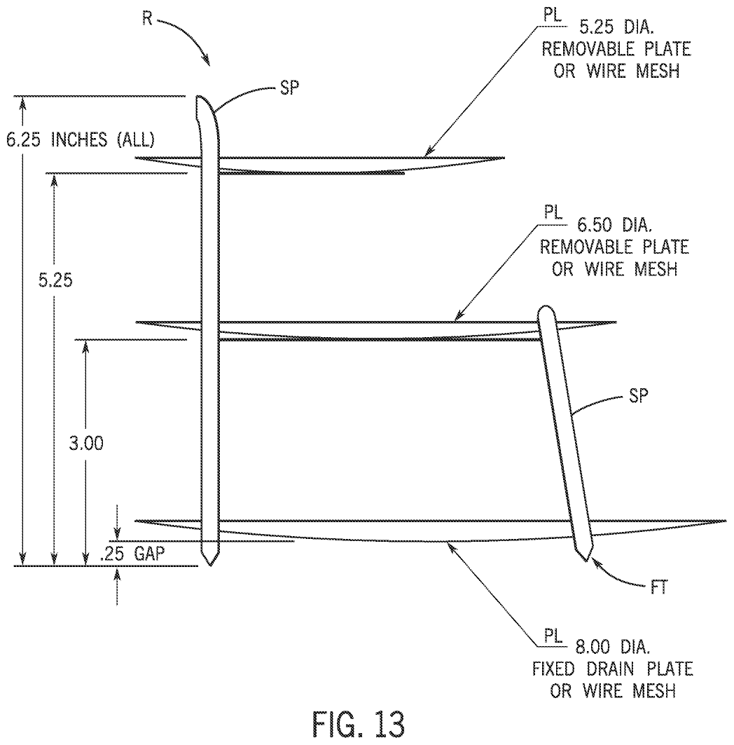

As shown schematically according to an exemplary embodiment in FIGS. 2, 3, 7A-7B, 10A-10B and 16, a cooking accessory/tool shown as rack R may be provided as an insert for the pot/liner PT of the cooking appliance IP. As shown schematically in FIGS. 2 and 3, the rack R may comprise a frame comprising a set of supports SP and a set of platforms PL for foodstuffs to be cooked in the cooking appliance IP. As indicated schematically in FIG. 3, the foodstuffs may comprise ingredients of a meat/protein ingredient P, carbohydrate ingredient C and vegetable/greens ingredient G. As shown schematically in FIGS. 2 and 3, 7A-7C and 10A-10B, the foodstuffs/ingredients may be arranged is a selected manner on platforms PL of the rack R which is placed and fit in the pot/liner PT in the base BS of the cooking appliance IP (along with fluid FL such as water at a selected level to facilitate heat transfer/cooking, boiling, steaming, etc. for the foodstuffs/ingredients on rack R within pot/liner PT); as indicated schematically in FIGS. 1, 7A and 16, cover CV is closed on the base BS of the cooking appliance IP and the foodstuffs (shown as comprising protein ingredient P, carbohydrate ingredient C and vegetable ingredient G) are cooked according to settings for operation are entered at the user interface (e.g. control panel CP and/or mobile device DV). As shown schematically in FIGS. 2, 3, 7A-7B, 12A-12B and 16, the rack R may be provided with a handle arrangement HD (shown representationally as integrated with frame supports SP) to facilitate handling of the rack R such as placement within and removal from pot/liner PT (with proper accommodation for elevated temperatures, such as a material treatment, etc.). As indicated schematically in FIGS. 2 and 3, the rack R may comprise three platforms PL; as indicated schematically in FIG. 11B, the rack R may comprise two platforms PL; according to an exemplary embodiment as indicated schematically in FIGS. 12A-12B and 13, the rack may comprise additional and/or adjustable and/or removable platforms.

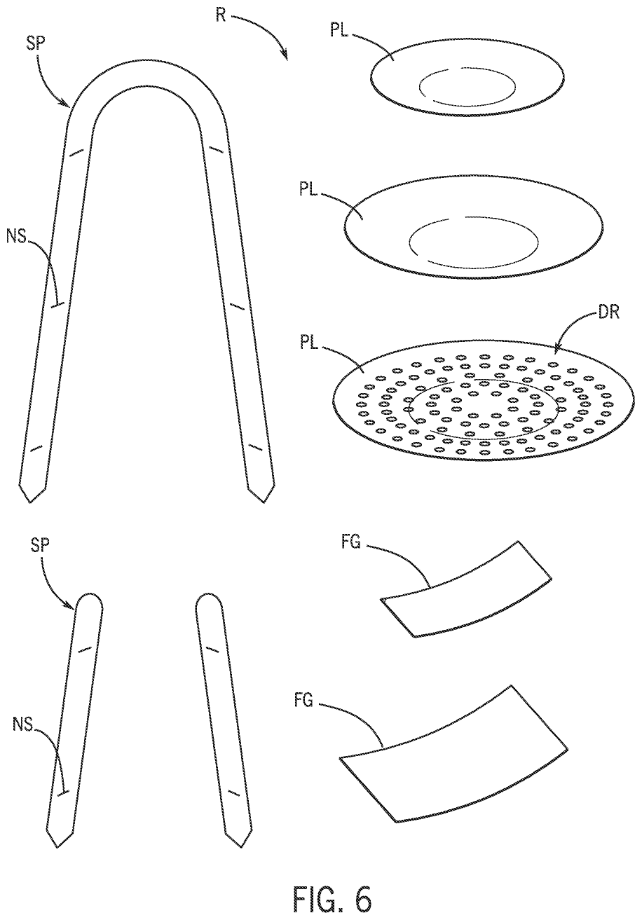

As indicated schematically according to an exemplary embodiment in FIGS. 2, 3, 4, 5, 6, 11A-11C, 12A-12B and 13, the rack R may be configured with the frame supports SP and platforms PL in any of a wide variety of arrangements; for example, generally flat platforms (e.g plate-shaped), curved platforms (e.g. bowl-shaped), mesh/grid platforms, wire/grid platforms, fixed platforms, removable platforms, adjustable-height platforms, varying sized platforms, varying shaped platforms, etc. As indicated schematically in FIGS. 2, 3, 4, 5, 6, 7A-7C, 11A-11C, the rack R may comprise platforms PL of a variety of sizes (large, medium, small, concentric, etc.) and shapes (round, oval, rectangular, etc.) and spacing and arrangement at height/levels (including arrangements and adjustments suited for particular foodstuffs/ingredients). See also FIG. 13 (indicating inch dimensions for a rack configured to fit within the pot/liner of commercially available cooking appliance (Instant Pot appliance with six-quart capacity)). As indicated schematically in FIG. 6, platforms PL may be supported on flanges/brackets FG on frame supports SP; as indicated schematically in FIGS. 12A-12B, platforms PL may be adjustable shown by insertion/fitment within grooves NS on frame supports SP (e.g. held by spring force, snap-in connectors, etc.); as indicated schematically in FIG. 13, platforms PL may be removable and/or relocatable on frame supports SP.

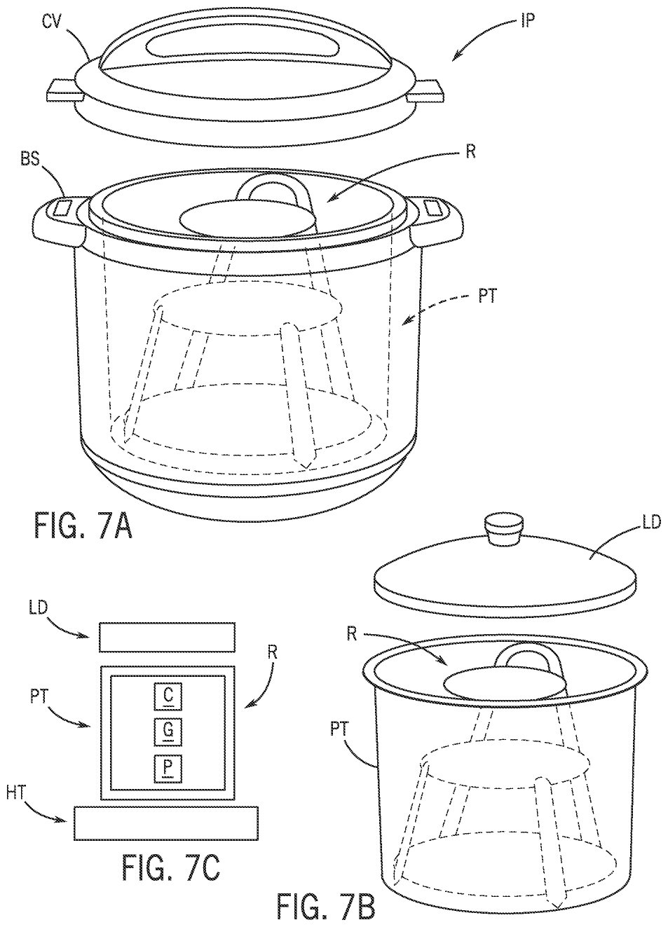

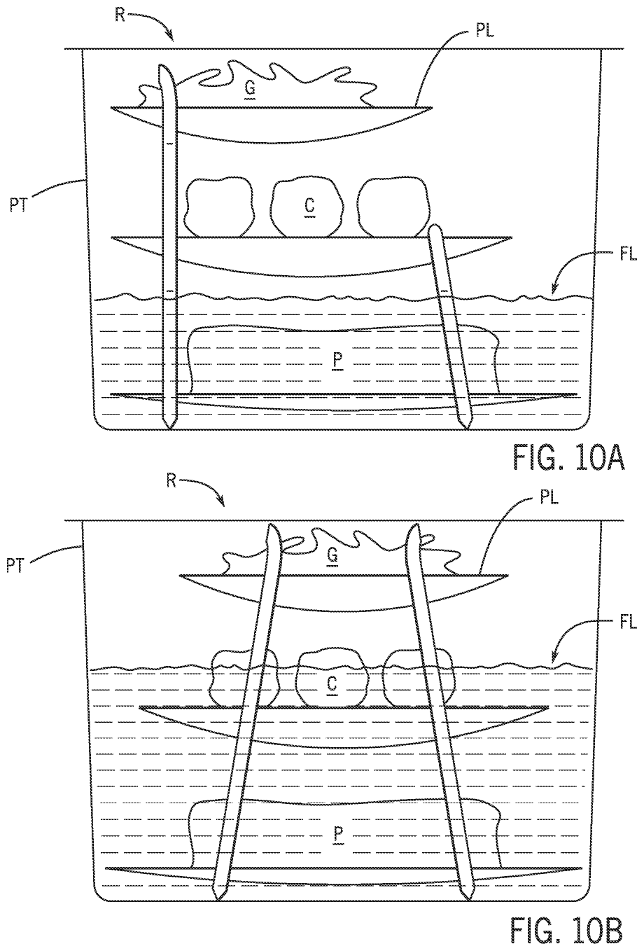

As indicated schematically in FIGS. 2, 3, 4, 5, 7A-7B, 10A-10B, 11A-11C, 12A-12B, 13 and 16, the rack R may comprise a form and construction to facilitate convenient/efficient fit within the pot/liner PT of the cooking appliance IP for cooking and to facilitate convenient/efficient use for meal service at table or counter and/or for post-meal clean-up (e.g. fit and/or partial disassembly for placement in a dishwasher, sink, etc.). See also FIG. 6 (showing schematically elements/parts of the rack that are affixed, welded, attached for construction of the rack according to an exemplary embodiment). As shown schematically in FIGS. 7B-7C, the rack R may be configured and/or used in a pot PT that is heated by a conventional heating element HT (e.g. such as provided on a stove top, by a hot plate, etc.); pot PT may be provided with a lid LD to cover the rack R with foodstuffs/ingredients for cooking. See also FIGS. 10A-10B (showing pot PT with rack R and fluid FL for cooking of foodstuff ingredients comprising protein P, carbohydrate C and vegetable matter G).

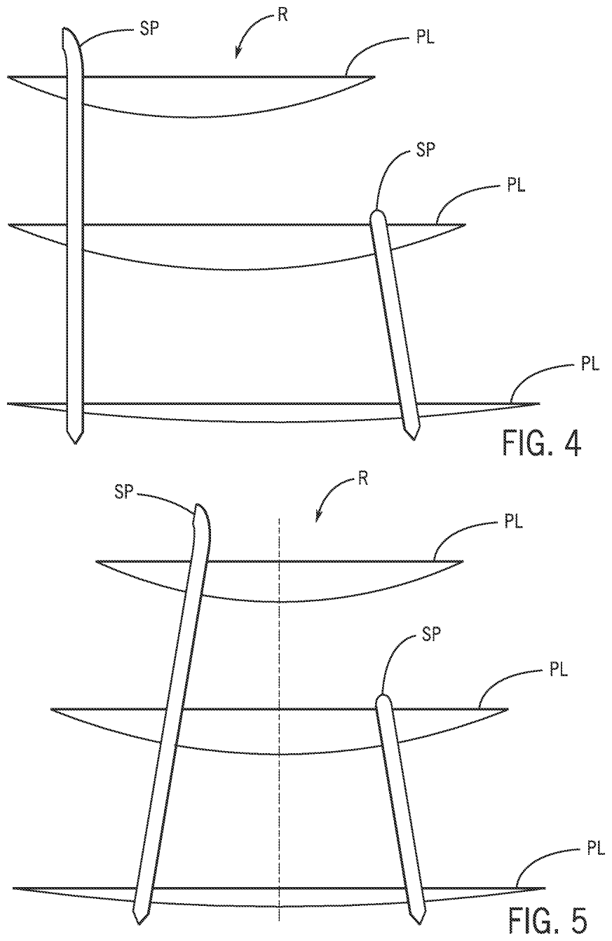

As indicated schematically in FIGS. 4 and 11A, the rack R may be configured with platforms PL that are in a varying set of sizes and arranged in an aligned manner (e.g. with frame support SP in a generally vertical alignment); as indicated schematically in FIGS. 5 and 12A-12B, the rack R may be configured with platforms PL that are in a varying set of sizes and arranged in a concentric manner (e.g. with frame supports SP in an angled orientation to accommodate the size/positioning of the platforms PL). As indicated schematically in FIGS. 11B-11C, the rack R may be configured with platforms PL that are of an oblong/oval and/or rectangular shape and generally of the same size (e.g. with frame supports SP in a generally vertical alignment). As indicated schematically in FIG. 13, the rack R may be configured with a base platform PL and removable platforms PL that may comprise the form of a flat plate and/or wire mesh; as shown schematically in FIG. 13, frame supports SP comprise feet FT that support the rack R within bottom of the pot/liner of the cooking appliance and on a surface when removed from the cooking appliance. See also FIGS. 10A-10B and 16.

As indicated schematically according to an exemplary embodiment in FIGS. 2, 12A-12B and 13, each of the platforms PL of the rack R by initial design/installation or selective adjustment/arrangement may omit or may comprise a set of drain holes DR in an arrangement configured for a particular purpose such as to facilitate cooking and/or for meal service of particular foodstuffs/ingredients (e.g. drain holes with varying sizes, with varying spacing, throughout the platform, at the edge/periphery of the platform, at the bottom of the platform, for full drainage, for partial drainage, no holes/no drainage, etc.). See also FIGS. 10A-10B (cooking) and FIGS. 3 and 10 (meal presentation/service).

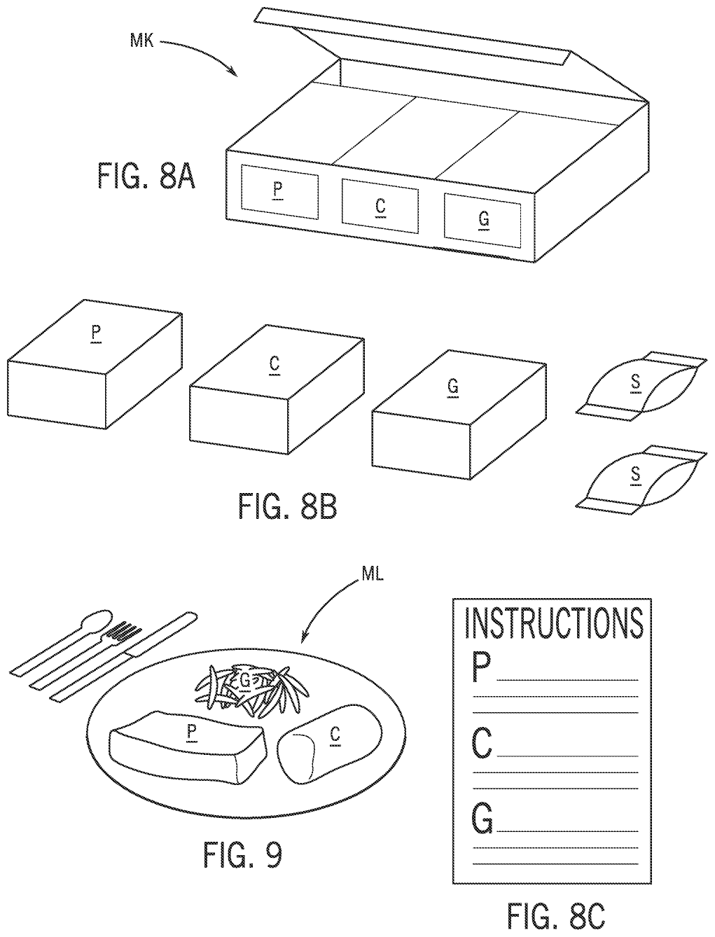

As indicated schematically in FIGS. 7A-7B and 10A-10B, the rack R may be configured to facilitate cooking with a varying level of water/fluid FL within the pot/liner PT (e.g. for immersed cooking, boiling, steaming, convection cooking, combinations, etc.) for each ingredient (e.g with the lower platform comprising foodstuffs/ingredient to be immersed in fluid FL and upper platform comprising foodstuffs/ingredient to be steamed/convection cooked above the level of fluid FL and a middle platform that can be arranged with a selected some combination of partial immersion, full immersion, non-immersion); as indicated schematically, by placement of the level of the platforms, placement of foodstuffs/ingredients on the platforms, determination of the fluid level, determination of settings for cooking, a wide variety of cooking methods may be employed with the rack (e.g. in a range from full immersion of all platforms to non-immersion of all platforms and any variation of immersion/non-immersion within the range). As shown schematically according to an exemplary embodiment in FIGS. 3, 7C, 10A-10B, 11A-11C and 16, the selection and arrangement of the foodstuff ingredients may be varied for the particular meal; the meat/protein ingredient P (if present) and/or the carbohydrate ingredient C (if present) and/or the vegetable/green ingredient G may be positioned to be cooked on any of the platforms (e.g. according to the intent of the cook, instructions, etc.). As indicated schematically in FIGS. 7A-7C, 10A-10B and 16, the settings for operation of the cooking appliance and/or heating element may be varied based on the selection of the foodstuff ingredients and time/meal planning. See also FIGS. 8C, 14C and 16 (instructions for preparation may include parameters/settings and/or control programs for cooking appliance).

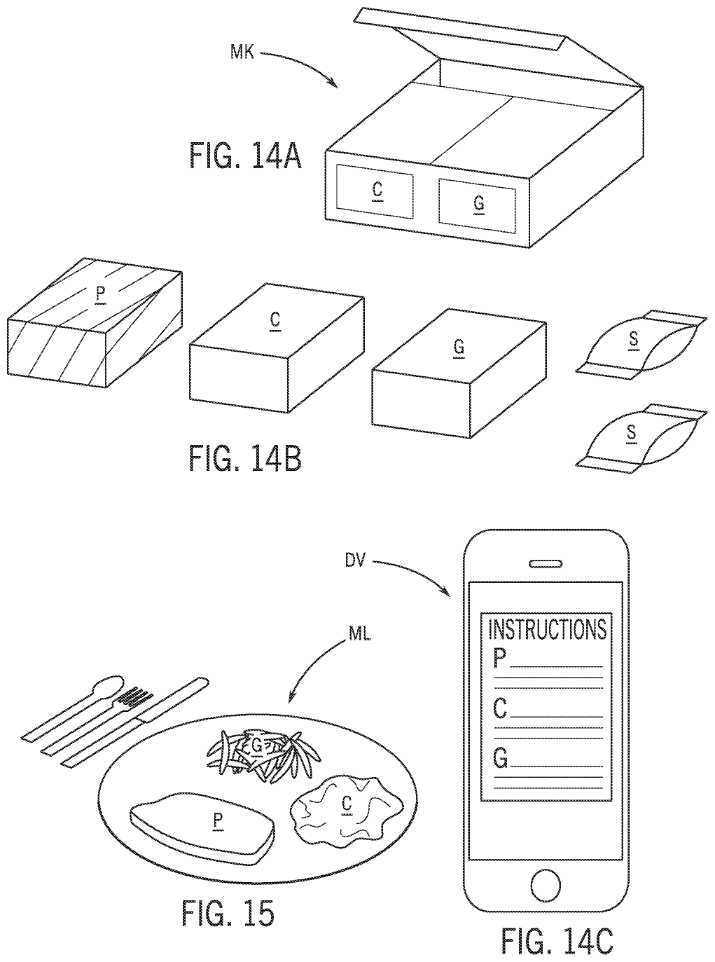

As shown schematically according to an exemplary embodiment in FIGS. 8A-8C and 9, the foodstuff ingredients of protein/meat P and carbohydrate C and vegetable G with seasoning/flavoring S and instructions for preparation of a meal LP may be provided in a meal kit MK. See also FIGS. 14A-14C and 15 (variation of meal kit MK comprising carbohydrate ingredient C and vegetable ingredient G but with separately obtained meat/protein ingredient P). As indicated schematically in FIGS. 8A-8B, 10A-10B, 11A-11C, the foodstuff ingredients from the meal kit MK (shown as separately packaged within the meal kit package) are placed on respective platforms PL of the rack R and cooked within the pot/liner PT of the cooking appliance IP. See also FIGS. 1, 3, 7A-7C and 16. As indicated schematically in FIGS. 8C and 14C, instructions for placement of the foodstuff ingredients on the rack R and for operation (e.g. cooking time, temperature, etc.) may be provided on an instruction card and/or by data communications to a device such as a mobile device on a network. See also FIG. 16 (indicating that settings for operation of the cooking appliance may also be provided by network connection directly to the cooking appliance and/or via a mobile device with data connection to the cooking appliance and/or over a network connection).

As shown schematically in FIGS. 1, 2, 3, 7A-7C, 10A-10B and 16, the cooking accessory shown as rack R with platforms PL for foodstuffs/ingredients to be cooked is configured to be fit in the pot/liner PT in the base of the cooking appliance IP and to be cooked (e.g. with fluid such as water in pot/liner with rack R and foodstuffs/ingredients) at parameters for operation (e.g. time, temperature, pressure, cycle, etc.) set at a user interface such as a control panel CP or on a network connection through a mobile device DV.

As shown schematically in FIGS. 2, 3, 4, 5 and 6, the rack R may comprise frame supports SP with feet FT and a set of platforms PL that may be installed with flanges/brackets FG or directly by connection to frame supports SP. See also FIGS. 11A-11C and 12A-12B. As indicated schematically, the platforms PL of rack R may be provided in a variety of number, type, forms, shape, size, spacing, positions, arrangements, and combinations. The rack may comprise a handle HD.

As shown schematically according to an exemplary embodiment in FIGS. 7A-7B, the rack R is configured to fit within a pot/liner PT within the base BS of the cooking appliance IP to be closed with cover CV. As shown schematically according to an exemplary embodiment in FIGURE C, the rack R may be configured to fit within a pot/liner PT under lid LD to be used with a cooking appliance providing a heating element HT (e.g. electric range top, gas burner, stovetop, hot plate, etc.). According to an exemplary embodiment, the rack can be made of a size and shape to fit within any of a wide variety of cooking appliances (e.g. pots/liner, base, cover, etc.). As indicated schematically, the cooking tool/accessory shown as insert rack may be made of any suitable type of cooking-safe material such as a stainless steel and/or temperature-safe plastics, composites, etc. The rack may be configured to fit (at least partially) within the cooking appliance (e.g. pot/liner in base) and for food service on a dining table.

As shown schematically, the foodstuffs/ingredients for the meal can be arranged/provided on the platforms PT of the rack R for cooking in the cooking appliance. As shown schematically in FIG. 8C, information such as instructions shown as on an instruction card for preparation of the meal from the meal kit may be included in or on the packaging of the meal kit. See also FIGS. 14C and 16 (instructions provided by data/network connection to a mobile device and/or the cooking appliance).

As shown schematically according to an exemplary embodiment in FIGS. 8A-8C and 9, a meal ML may be prepared from foodstuffs/ingredients such as a meat/protein P, a carbohydrate C and/or a vegetable G with a seasoning/flavoring S; the foodstuffs/ingredients may be packaged as a meal kit MK for convenient purchase/sale and/or delivery/carry-out such as by a customer to a home/household for preparation (e.g. from packaging as provided for ingredients and meal kit to placement in the cooking appliance with settings/parameters for cooking accessory). As shown schematically according to an exemplary embodiment in FIGS. 10A-10B and 11A-11C, the foodstuffs/ingredients of the meal kit are provided and arranged on the rack R and placed in the cooking appliance IP for cooking (e.g. according to instructions as provided such as on an instruction card or data communication); the rack R may be removed from the cooking appliance IP and used to present the foodstuffs/ingredients after cooking for service. See also FIGS. 3, 8C, 9, 14C, 15 and 16.

As shown schematically according to an exemplary embodiment in FIGS. 14A-14B and 15, the meal ML may be prepared from a meal kit MK that comprises part of the ingredients packaged and supplied shown as carbohydrate ingredient C and vegetable matter ingredient G; protein/meat ingredient P is purchased/packaged separately from the meal kit. As indicated schematically in FIG. 14C, instructions for preparation of the meal from the meal kit can be provided by data communication to a mobile device with an application (e.g program providing a user interface/format for display of instructions/information for preparation of a meal kit).

As shown schematically according to an exemplary embodiment in FIG. 16, the meal may be prepared from a meal kit MK that comprises foodstuffs/ingredients packaged and supplied shown as meat/protein ingredient P and carbohydrate ingredient C and vegetable matter ingredient G; information shown as provided as tag TG (e.g. RFID tag, bar code, QR code, identification/ID, other data set, etc.) on the packaging of the meal kit MK facilitates a data/network connection to a mobile device DV where information such as instructions, customer relationship management data, guidance, tips/help, social media/community, other internet sites/links, etc. can be interchanged (e.g. between the customer/user and vendor, others). As indicated schematically in FIG. 16, data/network communications may be established with the cooking appliance IP so that the settings/parameters for preparation of the meal kit are actuated (e.g. used or provided for adjustment by the customer); information may be provided so that setting/parameters for preparing the meal from the meal kit can be entered at control panel CP of the cooking appliance IP.

As indicated schematically in FIG. 16, a customer/user community may be established by the supplier/vendor of the cooking appliance and/or by the supplier/vendor of the meal kits; meal kits may be branded and/or fit for particular types of cooking appliances; cooking accessory shown as rack may be branded and/or fit for particular types of meal kits and particular types of cooking appliances; mobile device applications and data/network communications and/or websites may be established by suppliers/vendors and other related businesses to serve the user/customer community. As indicated schematically in FIG. 16, data/network communications during the cooking/preparation of the meal from the meal kit (including alerts, timers, warnings, cautions, reminders, etc.) maybe transmitted to the mobile device DV and/or at the control panel CP with the objective to complete a meal that is better than satisfactory for the customer/household. See also FIGS. 9 and 15 (meal as prepared from meal kit). As indicated schematically in FIG. 16, communications from the customer/household after completion after using instructions for preparation of the meal from the meal kit can be provided by data communication from a mobile device with an application (e.g program providing a user interface/format for display of instructions/information for preparation of a meal kit) to the user community, to social media/websites, to the supplier/vendor of the meal kit, to the supplier/vendor of the cooking appliance, to other business entities or others.

### Exemplary Embodiments—A

According to an exemplary embodiment a system and method for preparing a meal from a meal kit may comprises the steps of selecting a meal kit with foodstuff/ingredients and placement on the cooking accessory and placement of the cooking accessory in the cooking appliance and operation of the cooking appliance at parameters/settings for the meal kit and completion of cooking of the meal from the meal kit and service/presentation of the meal comprising the foodstuffs/ingredients as cooked to completion. See FIGS. 2-3, 7A-7C, 8A-8C, 9, 10A-10B, 14A-14C, 15 and 16.

According to an exemplary embodiment, the system comprises a meal kit (available in a variety of options) with greens G and carbohydrate C and protein P and seasoning S. See FIGS. 8A-8C, 9, 14A-14C and 15. The meal kit may be sized configured in a variety of forms, including a set of selected portion sizes (such as for 1 to 4 persons); instructions for the meal kit may be provided such as on an instruction card and/or available on a mobile device app (e.g ingredient placement on the cooking accessory, type of platform to be used, arrangement of platforms, staging of cooking, time/temperature, settings, etc.). See FIGS. 8C and 14C. As indicated schematically in FIGS. 8A-8B, 14A-14B and 16, the meal kit may be provided in a standard package of recyclable materials; the meal kit comprising ingredients may be maintained as frozen, refrigerated, fresh, dehydrated, canned/preserved, etc.; portion sizes of ingredients may be fit to the size of corresponding platforms on the rack/cooking accessory. See FIGS. 3, 8A-8B, 9, 14A-14B, 15 and 16.

As shown schematically in FIGS. 1, 2, 3, 7A-7B, 8A-8B, 9, 10A-10B and 16, the system may comprise a cooking tool/accessory comprising a three-level rack R configured to hold the sections/ingredients of the meal kit MK within the pot/liner PT of the cooking appliance IP (shown representationally as an Instant Pot appliance) with vegetable/greens ingredient G on the upper level and carbohydrates ingredient C on the middle level and protein/meat ingredient P on the lower level. As indicated schematically in FIGS. 10A-10B, with the rack R in the pot/liner PT in the base BS of the cooking appliance IP the protein ingredient P and carbohydrate ingredient C may be partially/wholly submerged in within a level of fluid FL shown as water/gravy during the cooking; the vegetable/greens ingredient G may be cooked by steaming within the pot/liner PT (e.g. with cover CV closed). See FIGS. 1 and 16. As indicated, variations of the cooking tool/accessory may be developed/selected. Compare FIGS. 2-3, 7A-7C, 10A-10B, 11A-11C and 12A-12B.

As indicated schematically in FIGS. 8A-8C and 14A-14C, the meal kit may be provided with protein ingredient P (see FIG. 8A) or without protein ingredient P (see FIG. 14A); the protein ingredient P can be provided by supplement/purchase according to instructions (such as provided on a mobile device app); other ingredients (including seasonings S) may be supplemented for the meal kit MK.

According to an exemplary embodiment as indicated schematically in FIGS. 8A-8C, 9, 14A-14C, 15 and 16, the meal kit MK may supply eco-friendly healthy-content for a meal available made at selected local grocers/outlets (and priced reasonably for a household) as conveniently-packaged foodstuffs/ingredients that can be quickly/easily/conveniently prepared such as with a cooking accessory shown as rack R in an cooking appliance IP (such as an Instant Pot appliance, available in choices/options available by visiting a website affiliated with the appliance or user/customer group (e.g. www.instantpot.com or social media site, etc.); according to an exemplary embodiment, meal kits will be fit to a particular cooking appliance (and cooking accessory/insert) and properly-portioned and fit for convenient use with the cooking tool/accessory insert for the cooking appliance. As indicated schematically in FIGS. 1, 7A-7B and 16, simple to follow instructions will facilitate efficient preparation of a meal from the meal kit; with instructions for use of cooking accessory/insert rack for foodstuffs/ingredients and operation of the cooking appliance (through control panel or mobile device) within minutes an enjoyable simple healthy meal can be served for a household; the cooking accessory is configured for easy clean-up and little waste. The cooking accessory/rack may be cleaned after use (e.g. in a dishwasher, sink, etc.).

### Exemplary Embodiments—B

According to an exemplary embodiment shown schematically in the FIGURES, a system and method for preparing a meal may comprise a cooking accessory configured to be used with a cooking appliance for foodstuffs; the cooking accessory may comprise a support structure and at least one platform configured to be supported by the support structure; the at least one platform may be configured to support foodstuffs; the support structure and the at least one platform may be configured to fit (at least partially) within the cooking appliance so that foodstuffs on the at least one platform can be heated within the cooking appliance; the support structure and the at least one platform may be configured for removal from the cooking appliance after foodstuffs have been heated. The foodstuffs may comprise contents for a meal; foodstuffs may comprise a meal kit comprising a meal comprising at least one of protein and/or carbohydrate and/or vegetable matter and/or seasoning; protein may comprise meat. The meal kit may be provided in a package; the package for the meal kit comprises a label; instructions for preparing the meal for the meal kit may be provided from the label; the label may be configured to be detected by a mobile device to provide instructions. The at least one platform comprises a lower platform and an upper platform; a rack may comprise the support structure and the lower platform and the upper platform; the rack may be configured to provide a middle platform between the lower platform and the upper platform; the lower platform may be attached to the rack. At least one platform may be removable from the rack. At least one platform may comprise a set of drain holes; at least one platform may comprise a wire mesh. The rack may be configured for placement into a fluid within the cooking appliance for heating foodstuffs on at least one platform of the rack. The support structure may comprise a stand; a meal comprising foodstuffs can be heated on the stand within the cooking appliance and served from the stand.

According to an exemplary embodiment shown schematically in the FIGURES, a cooking accessory such as a rack may be configured to be used with a cooking appliance for foodstuffs; the rack may comprise a support structure and at least one platform configured to be supported by the support structure; the at least one platform may be configured to support foodstuffs; the support structure and the at least one platform may be configured to fit (at least partially) within the cooking appliance so that foodstuffs on the at least one platform can be heated within the cooking appliance; the support structure and the at least one platform may be configured for removal from the cooking appliance after foodstuffs have been heated. The rack may comprise a handle.

According to an exemplary embodiment shown schematically in the FIGURES, a method of using a cooking accessory comprising a rack configured to be used with a cooking appliance to prepare a meal comprising foodstuffs from a meal kit may comprise the steps of (a) placing the foodstuffs on at least one platform of the rack; (b) placing the rack within the cooking appliance; (c) heating the foodstuffs on the at least one platform within the cooking appliance; (d) removing the rack from the cooking appliance after foodstuffs have been heated. Foodstuffs of the meal kit may comprise at least one of protein and/or carbohydrate and/or vegetable matter and/or seasoning. The meal kit may be provided in a package comprising a label; the method may comprise the step of obtaining instructions for preparing the meal for the meal kit from the label. The label may be configured to be detected by a mobile device to provide instructions; wherein the label may be configured to provide a data connection to a network from the mobile device.

According to an exemplary embodiment shown schematically in the FIGURES, a system for preparing a meal from a meal kit comprising ingredients in a cooking appliance may comprise a cooking accessory configured to fit (at least partially) within the cooking appliance and to provide a set of platforms for ingredients.

According to an exemplary embodiment shown schematically in the FIGURES, a system for preparing a meal from a meal kit comprising ingredients to be prepared in a cooking appliance may comprise a cooking accessory configured to fit (at least partially) within the cooking appliance and to provide a set of platforms for ingredients.

A system and method for a meal kit that can be prepared into a meal in a cooking appliance may comprise an eco-friendly packaged healthy-content meal kit with options for a household that can be quickly/easily and conveniently prepared in an appliance such as a pressure/time cooker appliance; the meal kit may be made available at selected local grocers/outlets. The meal kit may be properly-portioned and fit for convenient use with a new cooking tool/accessory insert for a pressure-cooker appliance. Instructions may be provided for preparation of the meal from the meal kit in the appliance using the tool/accessory; the meal kit may be configured to provide an enjoyable simple healthy meal to be served for a household. The meal kit may be configured to provide a meal with easy clean-up and little waste.

### System/Method

According to an exemplary embodiment a system and method for preparing a meal from a meal kit may comprises the steps of selecting a meal kit with foodstuff/ingredients (e.g. meat/protein, carbohydrate, vegetable matter, seasoning, etc.) and placing the foodstuff/ingredients on a cooking accessory such as a rack with platforms for each ingredient and placing the rack in a pot/liner for a cooking appliance such as a pressure cooker and the setting the parameters for operation to cook the ingredients into a meal (e.g. with water/steam, convection at pressure, time, temperature, etc.); then removing the cooking accessory/rack or the foodstuff/ingredients that have been cooked to serve the meal. The foodstuffs/ingredients of the meal kit may be any of a wide variety as can be prepared into a meal; the foodstuffs/ingredients may be frozen, fresh, refrigerated, shelf-stored, tetra-packed, treated/canned, dehydrated, etc. (or in some combination) when vended/sold in the kit. Meal kit ingredients may be fresh, frozen, refrigerated, boxed, dried/dehydrated, etc.; the meal kit ingredients may be combined with other foodstuffs/ingredients, supplemental content, combinations, etc. An identifier/tag providing data or data connectivity may be provided with or on the meal kit to facilitate information interchange with the customer and supplier/vendor of the meal kit or others in a business community/network or social community/network; information may comprise recommended setting for operation of the cooking appliance for the particular meal kit.

The system and method may comprise an eco-friendly-packaged healthy-content meal kit options for a household that can be quickly/easily and conveniently prepared in a cooking appliance such as a pressure/time cooker appliance; the meal kit may be made available at selected local grocers/outlets. The meal kit may be properly-portioned and fit for convenient use with a new cooking tool/accessory insert for a pressure-cooker appliance. Instructions may be provided for preparation of the meal from the meal kit in the appliance using the tool/accessory (accessible instructions in the packaging on a card, box, insert and/or available by data connection on a device such as a mobile phone); the meal kit may be configured to provide an enjoyable simple healthy meal to be served for a household. The meal kit may be configured to provide a meal with easy clean-up and little waste.

REFERENCE SYMBOL LIST

| SYMBOL | ELEMENT/ITEM |
|---|---|
| IP | Cooking appliance (e.g. Instant Pot, pressure cooker, |
| | crock pot, etc.) |
| CP | Control panel for cooking appliance |
| BS | Base of cooking appliance |
| CV | Cover of cooking appliance |
| PT | Pot/liner (container) for cooking appliance |
| LD | Lid for pot/liner |
| HT | Cooking appliance/heating element (e.g. stove top/ |
| | burner) |
| R | Cooking accessory/tool (e.g. rack, stand, etc.) |
| HD | Handle of cooking tool |
| PL | Platform (plate/bowl, wire mesh/rack, frame, etc.) |
| SP | Support/leg/frame piece |
| FT | Foot (of support) |
| FG | Flange/bracket for platform/frame |
| DR | Drain/hole of platform |
| NS | Insert/groove for assembly/adjustment |
| FL | Fluid (e.g. water, liquid, broth, etc.) for cooking |
| | appliance (pot/liner) |
| MK | Meal kit (with ingredients) |
| P | Protein foodstuff (e.g. meat, protein-base food, etc.) |
| | (ingredient) |
| G | Vegetable foodstuff (ingredient) |
| C | Carbohydrate foodstuff (ingredient) |
| S | Seasoning/flavoring (ingredient) |
| TG | Identification tag (RFID, QR code, bar code, identifier, |
| | etc.) for meal kit |
| ML | Meal (from meal kit) |
| DV | Mobile/electronic device (e.g. mobile telephone, |
| | iPhone, Android phone, computing device, etc.) |
| NETWORK | Network (e.g. home/business network, cloud/internet |
| | network, local area/local network, mesh network, |
| | Bluetooth/other network, etc.) |
| INSTRUCTIONS | Instructions for preparation of meal from meal kit |
| | (with ingredients) |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A cooking accessory configured to be used with a cooking appliance for foodstuffs comprising:
a support structure;
at least one platform configured to be supported by the support structure;
wherein the at least one platform is configured to support foodstuffs;
wherein the support structure and the at least one platform are configured to fit within the cooking appliance so that foodstuffs on the at least one platform can be heated within the cooking appliance;
wherein the support structure and the at least one platform are configured for removal from the cooking appliance after foodstuffs have been heated.

2. The cooking accessory of claim 1 wherein foodstuffs comprise contents such as ingredients for a meal.

3. The cooking accessory of claim 1 wherein foodstuffs comprise a meal kit comprising a meal comprising at least one of protein and/or carbohydrate and/or vegetable matter and/or seasoning.

4. The cooking accessory of claim 1 wherein the meal kit is provided in a package;
wherein the package for the meal kit comprises a label.

5. The cooking accessory of claim 4 wherein instructions for preparing the meal for the meal kit are provided from the label.

6. The cooking accessory of claim 4 wherein the label is configured to be detected by a mobile device to provide instructions.

7. The cooking accessory of claim 1 wherein the at least one platform comprises a lower platform and an upper platform.

8. The cooking accessory of claim 7 further comprising a rack comprising the support structure and the lower platform and the upper platform.

9. The cooking accessory of claim 7 wherein the rack comprises a middle platform between the lower platform and the upper platform.

10. The cooking accessory of claim 7 wherein the lower platform is attached to the rack.

11. The cooking accessory of claim 1 wherein at least one platform is removable from the rack.

12. The cooking accessory of claim 1 wherein at least one platform comprises a set of drain holes.

13. The cooking accessory of claim 1 wherein the at least one platform comprises a wire mesh.

14. The cooking accessory of claim 1 wherein the support structure comprises a rack providing at least one platform configured for placement into fluid within the cooking appliance for heating foodstuffs on at least one platform of the rack.

15. The cooking accessory of claim 1 wherein the support structure comprises a stand; wherein a meal comprising foodstuffs can be heated on the stand within the cooking appliance and served from the stand.

16. A rack configured to be used with a cooking appliance for foodstuffs comprising:
a support structure;
at least one platform configured to be supported by the support structure;
wherein the at least one platform is configured to support foodstuffs;
wherein the support structure and the at least one platform are configured to fit within the cooking appliance so that foodstuffs on the at least one platform can be heated within the cooking appliance;
wherein the support structure and the at least one platform are configured for removal from the cooking appliance after foodstuffs have been heated.

17. The rack of claim 16 further comprising a handle.

18. A method of using a cooking accessory comprising a rack configured to be used with a cooking appliance to prepare a meal comprising foodstuffs from a meal kit comprising the steps of:
(a) placing the foodstuffs on at least one platform of the rack;
(b) placing the rack within the cooking appliance;
(c) heating the foodstuffs on the at least one platform within the cooking appliance;
(d) removing the rack from the cooking appliance after foodstuffs have been heated;
wherein foodstuffs of the meal kit comprise at least one of protein and/or carbohydrate and/or vegetable matter and/or seasoning.

19. The method of claim 18 wherein the meal kit is provided in a package comprising a label and further comprising the step of obtaining instructions for preparing the meal for the meal kit from the label.

20. The method of claim 19 wherein the label is configured to be detected by a mobile device to provide instructions; wherein the label is configured to provide a data connection to a network from the mobile device.
